(19) United States
(12) Patent Application Publication
(10) Pub. No.: US 2022/0410442 A1
(43) Pub. Date: Dec. 29, 2022

(54) METHOD FOR MANUFACTURING POROUS MIDSOLE, AND POROUS MIDSOLE USING SAME

(71) Applicant: Shinhwan MOON, Busan (KR)

(72) Inventor: Shinhwan MOON, Busan (KR)

(21) Appl. No.: 17/779,762

(22) PCT Filed: Sep. 23, 2020
(86) PCT No.: PCT/KR2020/012817

§ 371 Date: May 25, 2022

(30) Foreign Application Priority Data
Dec. 9, 2019 (KR) 10-2019-0163025
Dec. 9, 2019 (KR) 10-2020-0035232

(51) Int. Cl. B29C 43/00; A43B 13/14; A43B 13/02; B29C 43/14; B29D 35/12; B29D 35/00; D04H 1/46; D04H 1/544; C09J 201/00

(52) U.S. Cl. CPC B29C 43/003; A43B 13/14; A43B 13/026; B29C 43/14; B29D 35/122; B29D 35/0054; D04H 1/46; D04H 1/544; C09J 201/00; B29L 2031/504

(57) ABSTRACT

Provided is a method for manufacturing a porous midsole the method including: a cotton-beating step (S1) of forming a midsole base (10) having porous voids 16 by mixing low melting fibers (12) and high melting fibers (14); and a thermoforming step (S2) of bonding and fixing the high melting fibers into a compressed state by the melt adhesive strength of the low melting fibers (12) by compressively thermoforming the midsole base (10) at a melting point temperature of the low melting fibers (12).

### TECHNICAL FIELD

The present disclosure relates to a method for manufacturing a porous midsole and a porous midsole using the same, and more particularly, to a method for manufacturing a porous midsole having high porosity and good ventilation and elasticity, and a porous midsole using the same.

### BACKGROUND ART

Typically, the midsole is the part of a shoe that is attached to the upper surface of the outsole of the shoe, under an upper that connects to the outsole of the shoe, which is used to close off a recessed curved portion of the outsole of the shoe and provide comfort when the insole is inserted, and which is usually laid onto the midsole.

Here, the midsole is made from one of synthetic resin materials such as urethane foam, P.V.C., T.P.R., or E.V.A. which have high durability so as to stably support the weight of the wearer. Recently, midsoles made from cotton obtained from recycled fiber or waste fiber have been developed and proposed as a way to reduce environmental pollution. However, they tend to lack in strength and do not provide good ventilation.

In this regard, Korean Patent Registration No. 10-1622706 discloses a conventional technique, which comprises a process of putting 40 kg of cotton, 80 kg of coconut fiber, and 30 kg of polypropylene in 3,000 kg of water and finely crushing and mixing them, a process of drying the mixture into a sheet, a process of composing a water-dispersible binder with a particle size of 0.1 μm to 1.5 μm, a solid content of 10 to 40% by weight, and a viscosity of 80 cps or less, a process of spraying the binder uniformly into the sheet by spraying on the top and suctioning on the bottom, and a process of performing primary molding of a mixture of the sheet and the binder at 180 to 200° C. by pressing it under 80 tons of pressure for 4 minutes, then applying a coating to the binder, and then performing secondary molding of the mixture at 180 to 200° C. by pressing it under 80 tons of pressure for 4 minutes. However, this technique has disadvantages of a delay in manufacturing process time and low productivity, since the cotton, the coconut fiber, and the polypropylene have to be fine-crushed when mixed with water and also need to go through the primary and second molding steps to secure the strength.

As another conventional technology, Korean Patent Registration No. 10-0661932 discloses an assembly-type shoe midsole comprising a midsole made by cutting a single original sheet-sponge complex, an iron core positioned underneath the midsole, and a reinforcing sole positioned underneath the iron core, in which the midsole forms a sponge layer to cover the original sheet all the way from the front end to the middle part, and the material of the original sheet is one selected from the group consisting of compressed paper, compressed fiber, and non-woven fabric, the sponge is subjected to heat at a temperature of 100 to 600° C. such that its thickness tapers off toward the middle part from the front end of the original sheet, and the sponge is compressed against the original sheet by a roller. However, the multilayered structure composed of the iron core, the reinforcing sole, the sponge layer, and the original sheet makes the manufacturing process complicated, and most of all, obstructs ventilation, which may cause the propagation of a variety of harmful bacteria when exposed to wet environments.

### PRIOR ART DOCUMENTS

(Patent Document 1) KR 10-1622706 B1 (2016 May 13)
(Patent Document 2) KR 10-0661932 B1 (2006 Dec. 20)

### SUMMARY OF THE INVENTION

### Technical Problem

To solve the above problems occurring in the conventional art, the present disclosure has devised a new technology, which aims to provide a method for manufacturing a porous midsole by bonding and fixing high melting fibers through compressive thermoforming by using a difference in melting-point temperature between low melting fibers and the high melting fibers, the midsole having a peripheral area L1 and a central area L2 with different densities and strengths, and a porous midsole using the same.

The present disclosure also aims to provide a method for manufacturing a porous midsole, in which high melting fibers are adhesively bonded by means of low melting fibers when the midsole is compressively thermoformed, so as to provide high porosity in the central area L2 of the midsole.

### Solution to Problem

An embodiment of the present disclosure provides a method for manufacturing a porous midsole, the method including: a cotton-beating step (S1) of forming a midsole base 10 having porous voids 16 by mixing low melting fibers 12 and high melting fibers 14; and a thermoforming step (S2) of bonding and fixing the high melting fibers 14 into a compressed state by the melt adhesive strength of the low melting fibers 12 by compressively thermoforming the midsole base 10 at a melting point temperature of the low melting fibers 12.

The low melting fibers 12 are formed of synthetic fiber yarns of 3 to 7 denier whose melting point is 140° C., and the high melting fibers 14 are formed of either or both of polyethylene yarns and polypropylene yarns of 3 to 40 denier whose melting point is 160 to 250° C., and the midsole base 10 is put into a heated press mold and compressively thermoformed under a pressure of 100 kg/cm2 to 120 kg/cm2 at the melting point temperature of the low melting fibers 12.

In the thermoforming step S2, the midsole base 10 is cut to a size covering a midsole portion 100 and a cutout portion 200 and compressively thermoformed in the press mold, and a gouge 300 is formed on the boundary between the midsole portion 100 and the cutout portion 200, and after the compressive thermoforming, the midsole portion 100, along with the cutout portion 200, is taken out from the press mold and then cooled and hardened, during which its shape is maintained by the cutout portion 200.

Another embodiment of the present disclosure provides a porous midsole using a method for manufacturing a porous midsole, the porous midsole including a midsole portion 100, which is produced in such a way that a midsole base 10 having porous voids 16 is formed from a mixture of low melting fibers 12 and high melting fibers 14, and the high melting fibers 14 are bonded and fixed so that the porous voids 16 are formed between the high melting fibers 14 by the melt adhesive strength of the low melting fibers 12 by compressively thermoforming the midsole base 10 at a melting point temperature of the low melting fibers 12.

A bottom peripheral area L1 of the midsole portion 100 is compressively thermoformed to a smaller thickness compared to a central area L2, thereby forming an engraved strip-shaped groove 110 where an upper 1 is attached, and the peripheral area L1 is formed as a heterogeneous layer having a different thickness, density, and strength than the central area L2 as the low melting fibers 12 and the high melting fibers 14 are melted and fused together.

reinforcing strip grooves 120 are formed in the bottom of the central area L2, but are not formed in the bottom peripheral area L1 of the midsole portion 100, and the reinforcing strip grooves 120 are formed as a high-density layer in comparison to the central area L2 as the low melting fibers 12 and the high melting fibers 14 are melted and fused together.

The central area L2 of the midsole portion 100 is divided into a reinforcing plate portion 101 corresponding to a midfoot portion P2 and hindfoot portion P3 where the reinforcing strip grooves 120 are formed, and an elastic plate portion 102 corresponding to a forefoot portion P1 where the reinforcing strip grooves 120 are not formed.

### Advantageous Effects of Invention

According to a concrete means for solving the above-described problems, the present disclosure allows the high melting fibers to be bonded and fixed through compressive thermoforming by using a difference in melting-point temperature between the low melting fibers and the high melting fibers, thereby manufacturing a midsole with an edge (peripheral) portion that provides good strength and durability because of its high density.

Moreover, a central area of the midsole has high porosity due to its low density as the high melting fibers are adhesively bonded by means of the low melting fibers, and therefore greatly improves ventilation and elasticity, making this midsole highly useful as a midsole for a functional shoe.

### BRIEF DESCRIPTION OF DRAWINGS

FIG. 1 is a flowchart of a method for manufacturing a porous midsole according to the present disclosure.

FIG. 2 is a flowchart schematically showing steps of a method for manufacturing a porous midsole according to the present disclosure.

FIG. 3 is a configuration diagram of a porous midsole manufactured by a method for manufacturing a porous midsole according to the present disclosure.

FIG. 4 is a longitudinal sectional view of an engraved strip-shaped groove in a porous midsole according to the present disclosure.

FIG. 5 is a configuration diagram of a porous midsole with reinforcing strip grooves formed therein.

FIG. 6 is a bottom perspective view showing reinforcing strip grooves formed in the bottom of a porous midsole.

### DETAILED DESCRIPTION OF THE INVENTION

Hereinafter, an exemplary embodiment of the present disclosure will be described in detail with reference to the accompanying drawings. The terms “about”, “substantially”, etc. in the present disclosure are used to indicate inherent preparation and substance related tolerance. This is intended to prevent an unscrupulous infringer to design around accurate or absolute values set forth to aid understanding of the present disclosure.

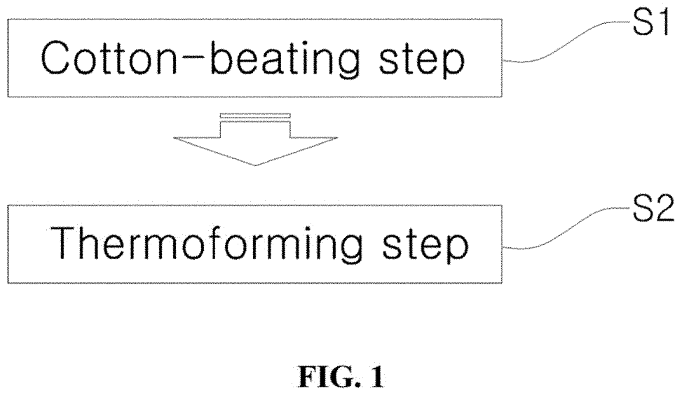

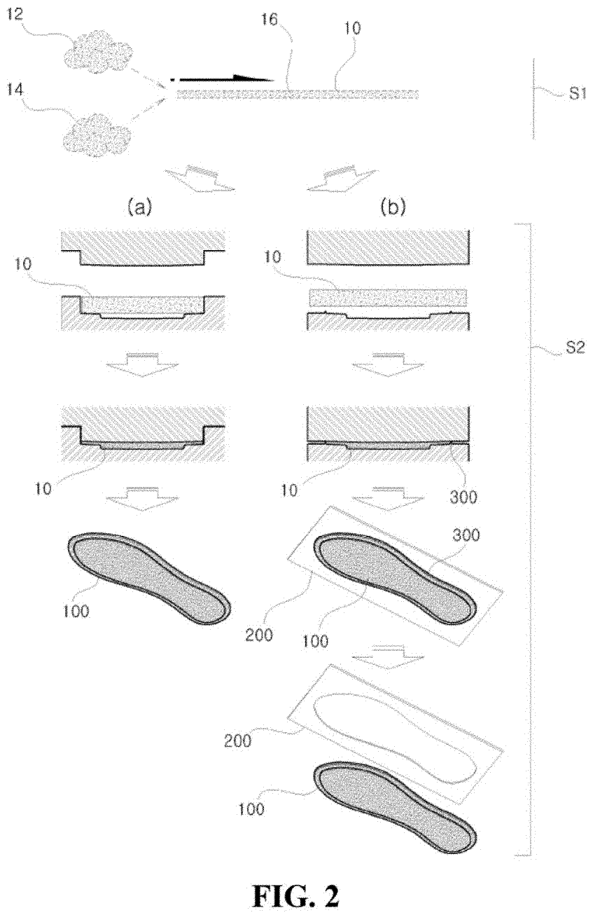

FIG. 1 is a flowchart of a method for manufacturing a porous midsole according to the present disclosure. FIG. 2 is a flowchart schematically showing steps of a method for manufacturing a porous midsole according to the present disclosure.

The present disclosure relates to a method for manufacturing a porous midsole and a porous midsole using the same, the method mainly including a cotton-beating step S1 and a thermoforming step S2, which provides good strength and water resistance by bonding and fixing high melting fibers through compressive thermoforming by using a difference in melting-point temperature between low melting fibers and the high melting fibers, and also provides high porosity, ventilation, and elasticity by adhesively bonding the high melting fibers by means of the low melting fibers.

1. Cotton-Beating Step (S1)

The cotton-beating step (S1) according to the present disclosure is a step of forming a midsole base 10 having porous voids 16 by mixing low melting fibers 12 and high melting fibers 14.

The low melting fibers 12 and the high melting fibers 14 are prepared in the form of a cotton mix, and the cotton mix is put into a cotton beater and drawn to a given thickness to fix the tissues by needle punching. The midsole 10 is made twice to four times thicker than a final midsole product in consideration of the compression rate in the thermoforming step S2 to be described later.

The low melting fibers 12 are formed of synthetic fiber yarns of 3 to 7 denier whose melting point is 140° C., and the high melting fibers 14 are formed of either or both of polyethylene yarns and polypropylene yarns of 3 to 40 denier whose melting point is 160 to 250° C. Here, a midsole manufactured from polyethylene yarns as the high melting fibers 14 provides a fabric-like feel, and a midsole manufactured from polypropylene yarns as the high melting fibers 14 provides a paper-like feel.

Moreover, since the high melting fibers 14 have a thickness of 3 to 40 denier, voids are formed between the high melting fibers 14 when a final midsole product 100 is formed through the thermoforming step S2 to be described later. Here, the higher the denier of the high melting fibers 14, the higher the porosity but the lower the strength, and the lower the denier of the high melting fibers 14, the lower the porosity but the higher the strength. That is, the porosity and the strength are in inverse proportion to each other. Thus, the high melting fibers 14 preferably have a thickness of 3 to 40 denier in order to meet the ventilation and strength required for the midsole.

Meanwhile, since the high melting fibers 14 have a melting point temperature of 160 to 250° C., the low melting fibers 12 where the high melting fibers 14 are melted and bonded are formed of synthetic fiber yarns having a melting point temperature below 160° C.—that is, 140° C. or lower, and provide good adhesion. Although the components and materials of the high melting fibers 14 are specified in the above, they are not limited to the above but may be formed by using monofilament yarns or synthetic filament yarns whose melting point temperatures are different.

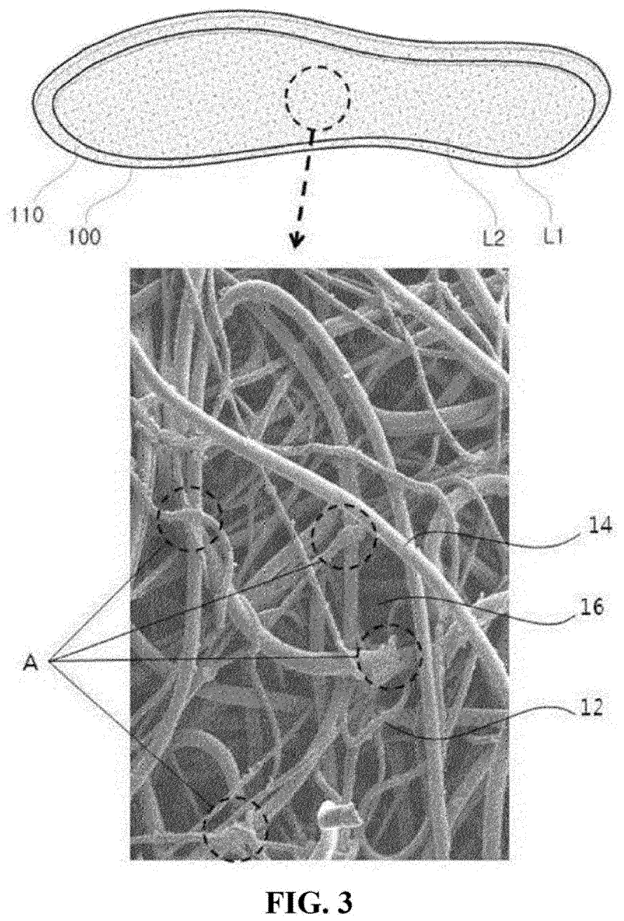

Since the low melting fibers 12 are formed of a low melting material with a low melting point of 140° C. or lower, they are melted at a lower temperature than the high melting fibers 14, in the thermoforming step S2 to be described later, so that porous voids 16 are formed between the high melting fibers 14 which are adhesively bonded (as indicated by ‘A’ in FIG. 3).

Moreover, as the amount of low melting fibers 12 relative to high melting fiber 14 decreases, the porosity of the final midsole product increases but its hardness decreases. On the other hand, as the amount of low melting fibers 12 increases, the porosity of the final midsole product decreases but its hardness increases. Thus, the amount of low melting fibers 12 may be properly adjusted depending on the type of the shoe for which the midsole manufactured according to the present disclosure is used. For example, the proportion of low melting fibers 12 may be increased when they are used for hard shoes such as military boots, safety shoes, and formal shoes, whereas the proportion of low melting fibers 12 may be decreased when they are used for lightweight, highly flexible shoes such as running shoes and athletic shoes, in order to improve ventilation.

2. Thermoforming Step (S2).

The thermoforming step (S2) according to the present disclosure is a step of bonding and fixing the high melting fibers 14 into a compressed state by the melt adhesive strength of the low melting fibers 12 by compressively thermoforming the midsole base 10 at a melting point temperature of the low melting fibers 12. The midsole base 10 is put into a heated press mold and compressively thermoformed under a pressure of 100 kg/cm2 to 120 kg/cm2 at the melting point temperature of the low melting fibers 12.

For example, when the midsole base 10 is in an uncompressed state with a thickness of 7 to 12 mm after it has undergone the step S1, it is compressed to a thickness of 2 to 5 mm through compressive thermoforming in the thermoforming step S2, and at the same time, the high melting fibers 14 are bonded and fixed by means of the low melting fibers 12, thereby manufacturing a compression plate-like midsole with a given strength.

In this case, if there is a delay in compressive thermoforming in the thermoforming step S2, the low melting fibers 12 are excessively melted and intertwined together to form a layer, causing a decrease in porosity. On the contrary, if the compressive thermoforming time is short, the applied low melting fibers 12 do not melt entirely, thus leading to a decrease in strength. Thus, the compressive thermoforming time is preferably set to 20 to 40 seconds so that the low melting fibers 12 and the high melting fibers 14 are optimally bonded together.

A midsole manufactured according to this manufacturing method provides good ventilation and higher strength and elasticity, which helps maintain the shape of the midsole even if the midsole is designed ergonomically in a three-dimensional shape to fit the curve of the wearer's sole. Accordingly, when this midsole is used for hard shoes such as forma. shoes or military shoes, it helps keep the wearer's feet airy and comfortable because of its good ventilation and ergonomic shape.

Moreover, in the thermoforming step S2, the midsole base 10 is cut to a size covering a midsole portion 100 and a cutout portion 200 and the midsole base 10 is compressively thermoformed in the press mold, and a gouge 300 is formed on the boundary between the midsole portion 100 and the cutout portion 200. The gouge 300 is made as thin as 10 to 20% of the thickness of the final midsole product. Thus, once the midsole 10 is cooled and hardened after the compressive thermoforming, the midsole portion 100 and the cutout portion 200 are cut off from each other with respect to the gouge 300.

That is, as shown in (b) of FIG. 2, after the compressive thermoforming, the midsole portion 100, along with the cutout portion 200, is taken out from the press mold and then cooled and hardened, during which its shape is maintained by the cutout portion 200. This prevents deformation caused by bending when the midsole 100 is taken out after the compressive thermoforming, and also prevents distortion and deformation during the cooling and hardening since the shape is maintained by the cutout portion 200.

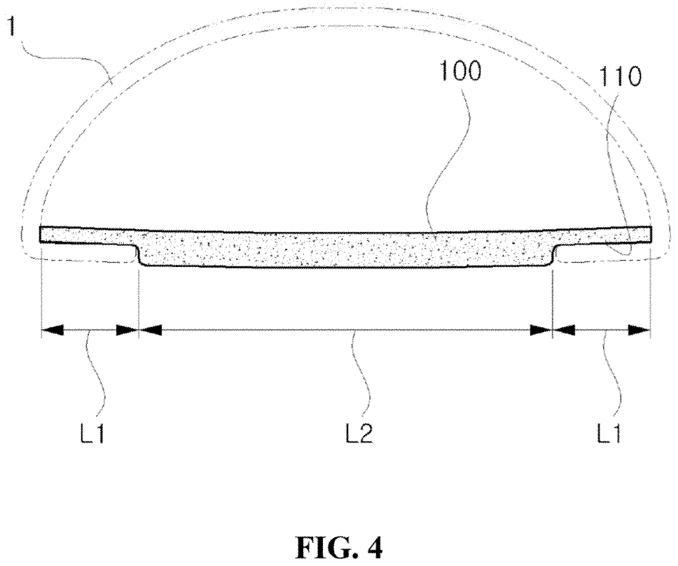

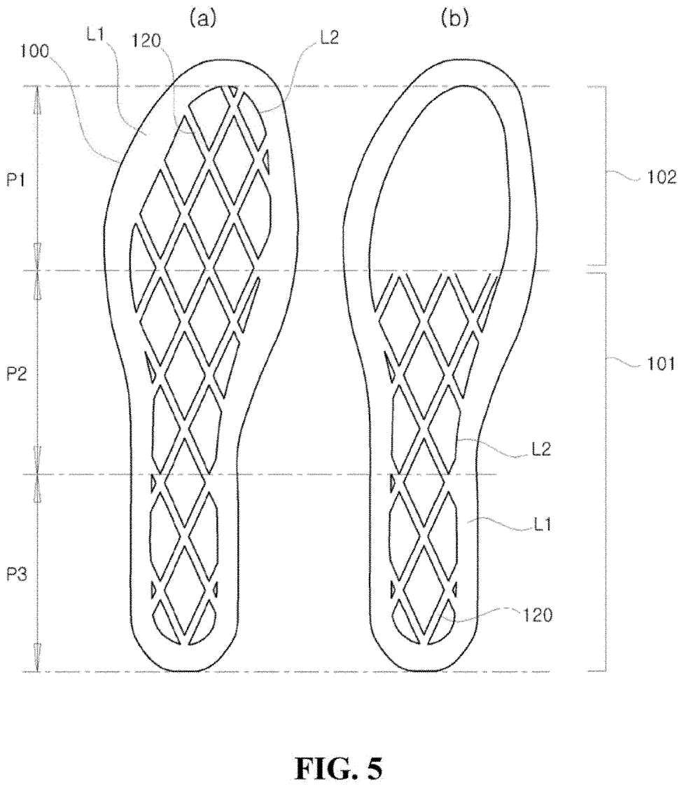

FIG. 3 is a configuration diagram of a porous midsole manufactured by a method for manufacturing a porous midsole according to the present disclosure. FIG. 4 is a longitudinal sectional view of an engraved strip-shaped groove in a porous midsole according to the present disclosure. FIG. 5 is a configuration diagram of a porous midsole with reinforcing strip grooves formed therein.

A porous midsole using the method for manufacturing a porous midsole according to the present disclosure includes a midsole portion 100, which is produced in such a way that a midsole base 10 having porous voids 16 is formed from a mixture of low melting fibers 12 and high melting fibers 14, and the high melting fibers 14 are bonded and fixed so that the porous voids 16 are formed between the high melting fibers 14 by the melt adhesive strength of the low melting fibers 12 by compressively thermoforming the midsole base 10 at a melting point temperature of the low melting fibers 12. Here, the porous midsole is manufactured by the above method for manufacturing a porous midsole, so a detailed description of the manufacturing method will be omitted.

In this case, a bottom peripheral area L1 of the midsole portion 100 is compressively thermoformed to a smaller thickness compared to a central area L2, thereby forming an engraved strip-shaped groove 110 where an upper 1 is attached, in the shoe manufacturing process, and the peripheral area L1 is formed as a heterogeneous layer having a different thickness, density, and strength than the central area L2 as the low melting fibers 12 and the high melting fibers 14 are melted and fused together.

That is, the bottom peripheral portion at the lower core of a molding machine for compressive thermoforming is compressively thermoformed at a higher elevation than the central area. Thus, the engraved strip-shaped groove 110 is formed on the bottom peripheral area L1 of the midsole base 10, and the engraved strip-shaped groove 110 is recessed to a depth of 1.6 to 2.4 mm in consideration of the thickness of the upper 1 which ranges from 1.6 to 2.4 mm. In this case, the central area L2 is made 1.5 to 3 times as thick as the peripheral area L1.

The central area L2 with a larger thickness has a lower density than the peripheral area L1 with a smaller thickness but instead provides high permeability, elasticity, and flexibility.

In view of this, in the manufacturing process of a shoe, when the upper 1 is joined to cover the bottom peripheral area of the midsole base 10, the upper 1 is attached to the engraved strip-shaped groove 110 as shown in FIG. 4. Thus, the bottom of the midsole base 10 is kept flat even after the upper 1 is attached, and therefore the midsole base 10 can be firmly secured to the outsole, and the shape of the midsole can be maintained when the shoe is worn.

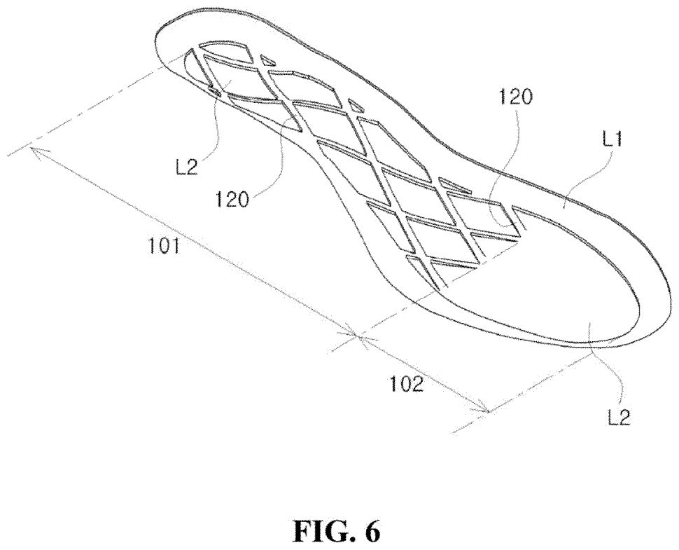

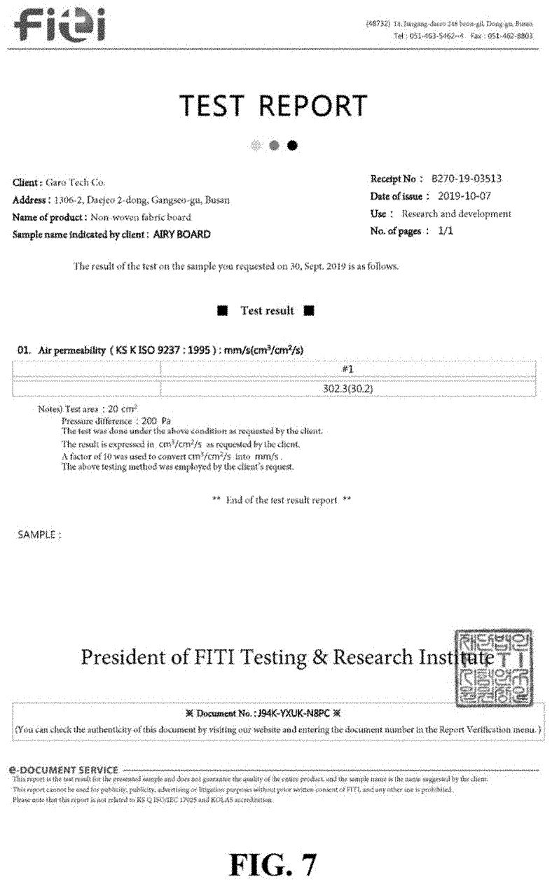

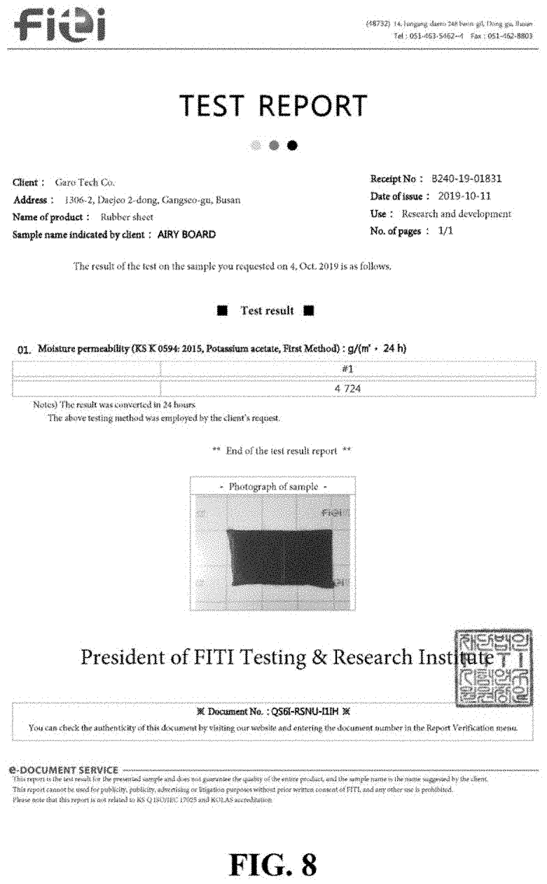

FIG. 5 is a configuration diagram showing an example of forming reinforcing strip grooves in a porous midsole provided in the present disclosure. FIG. 6 is a bottom perspective view showing reinforcing strip grooves formed in the bottom of a porous midsole. reinforcing strip grooves 120 are formed in the bottom of the central area L2, and the reinforcing strip grooves 120 are formed as a high-density layer in comparison to the central area L2 as the low melting fibers 12 and the high melting fibers 14 are melted and fused together. Therefore, the midsole has high strength despite its thinness, although there is still room for improvement in ventilation.

The reinforcing strip grooves 120 are compressively thermoformed as thin as 10 to 50% of the thickness of the central area L2, and are latticed across the entire central area L2 as shown in (a) of FIG. 5 to reinforce the bending strength of the shoe during walking, thereby stably supporting a midfoot portion P2 and hindfoot portion P3 of the sole.

In another embodiment, as illustrated in (b) of FIG. 5 and FIG. 6, the central area L2 of the midsole portion 100 is divided into a reinforcing plate portion 101 corresponding to a midfoot portion P2 and hindfoot portion P3 where the reinforcing strip grooves 120 are formed, and an elastic plate portion 102 corresponding to a forefoot portion P1 where the reinforcing strip grooves 120 are not formed. In this case, the reinforcing strip grooves 120 with high strength are not formed in the forefoot portion, which gives elasticity and flexibility to bending deformation when the toes are flexed during walking.

As such, the area of the midsole portion 100 corresponding to the midfoot portion P2 and the hindfoot portion P3 is given high strength by the reinforcing strip grooves 120, whereas the area corresponding to the forefoot portion P1 is flexibly and elastically deformed. This makes the bottom of the shoe flex and extend easily and smoothly during walking and therefore provides softness and comfort when the toes are flexed, and also provides better ventilation to the forefoot portion from which much sweat is produced.

FIGS. 7 and 8 are copies of results from air permeability and moisture permeability tests conducted on samples of the present disclosure by the Fabric Inspection Testing Institute (FITI) in South Korea, in order to make an objective analysis on air permeability and moisture permeability. The samples used in the tests were taken from the central area L2 of FIG. 3.

For air permeability, the volume of air in cm3 which is passed through in one second through 1 cm2 of fabric at a pressure difference of 200 Pa was 302.3 (cm3/cm2/s).

The result of the water permeability test, which was done to measure the ability of a fabric to allow moisture vapor from human sweat to escape through the material, shows that 4,724 g of moisture vapor was released through a square meter of fabric in 24 hours.

As seen from above, a midsole manufactured by the manufacturing method of the present disclosure may be widely used for the bottom of a functional shoes since it has high strength to prevent distortion of the bottom of the shoe and also provides good ventilation and moisture permeability, and therefore it may offer a wide variety of industrial applications.

Although the most preferred embodiment of the present disclosure has been described in the detailed description of the present disclosure as described above, the present disclosure may be variously modified without departing from the technical range of the present disclosure. Accordingly, the range of protection of the present disclosure should not be limited to the embodiment, but the technologies of the claims and equivalent technical means from these technologies should be recognized as the range of protection of the present disclosure.

1. A method for manufacturing a porous midsole, the method comprising:
a cotton-beating step (S1) of forming a midsole base (10) having porous voids 16 by mixing low melting fibers (12) and high melting fibers (14); and
a thermoforming step (S2) of bonding and fixing the high melting fibers into a compressed state by the melt adhesive strength of the low melting fibers (12) by compressively thermoforming the midsole base (10) at a melting point temperature of the low melting fibers (12).

2. The method of claim 1,
wherein the low melting fibers (12) are formed of synthetic fiber yarns of 3 to 7 denier whose melting point is 140° C., and the high melting fibers (14) are formed of either or both of polyethylene yarns and polypropylene yarns of 3 to 40 denier whose melting point is 160 to 250° C., and the midsole base (10) is put into a heated press mold and compressively thermoformed under a pressure of 100 kg/cm² to 120 kg/cm² at the melting point temperature of the low melting fibers (12).

3. The method of claim 1,
wherein, in the thermoforming step (S2), the midsole base (10) is cut to a size covering a midsole portion (100) and a cutout portion (200) and compressively thermoformed in the press mold, and a gouge (300) is formed on the boundary between the midsole portion (100) and the cutout portion (200), and after the compressive thermoforming, the midsole portion (100), along with the cutout portion (200), is taken out from the press mold and then cooled and hardened, during which its shape is maintained by the cutout portion (200).

4. A porous midsole using the method for manufacturing a porous midsole according to claim 1, the porous midsole comprising:
a midsole portion (100), which is produced in such a way that a midsole base (10) having porous voids (16) is formed from a mixture of low melting fibers (12) and high melting fibers (14),
wherein the high melting fibers (14) are bonded and fixed so that the porous voids (16) are formed between the high melting fibers (14) by the melt adhesive strength of the low melting fibers (12) by compressively thermoforming the midsole base (10) at a melting point temperature of the low melting fibers (12).

5. The porous midsole of claim 4,
wherein a bottom peripheral area (L1) of the midsole portion (100) is compressively thermoformed to a smaller thickness compared to a central area (L2), thereby forming an engraved strip-shaped groove (110) where an upper (1) is attached, and the peripheral area (L1) is formed as a heterogeneous layer having a different thickness, density, and strength than the central area (L2) as the low melting fibers (12) and the high melting fibers (14) are melted and fused together.

6. The porous midsole of claim 4,
wherein reinforcing strip grooves (120) are formed in the bottom of the central area (L2), but are not formed in the bottom peripheral area (L1) of the midsole portion (100), and the reinforcing strip grooves (120) are formed as a high-density layer in comparison to the central area (L2) as the low melting fibers (12) and the high melting fibers (14) are melted and fused together.

7. The porous midsole of claim 6,
wherein the central area (L2) of the midsole portion (100) is divided into a reinforcing plate portion (101) corresponding to a midfoot portion (P2) and hindfoot portion (P3) where the reinforcing strip grooves (120) are formed, and an elastic plate portion (102) corresponding to a forefoot portion (P1) where the reinforcing strip grooves (120) are not formed.
